(19) United States
(12) Patent Application Publication
(10) Pub. No.: US 2002/0025106 A1
(43) Pub. Date: Feb. 28, 2002

(54) Mechanically latching optical switch

(76) Inventor: Stephen Alan Raccio, Oxford, CT (US)

Correspondence Address: MORRISON & FOERSTER LLP, 2000 PENNSYLVANIA AVE, NW, SUITE 5500, WASHINGTON, DC, 20006-1888, US

(21) Appl. No.: 09/770,677

(22) Filed: Jan. 29, 2001

Related U.S. Application Data
(60) Provisional application No. 60/178,660, filed on Jan. 28, 2000.

(51) Int. Cl. G02B 6/35

(52) U.S. Cl. 385/18

(57) ABSTRACT

A method and apparatus for directing an optical beam, such as a laser beam used in an optical communications network. A micromirror is actuated to encounter, is mechanically latched by, a latching mechanism which holds the micromirror in position even when the actuating force is subsequently removed. The micromirror may subsequently be released to an unactuated state. The invention allows low power actuation and fixed latching without the need for additional power after switching has occurred. The latching mechanism provides a fixed stop which eliminates the need for active feedback to align the switching micromirror and provides tolerance to shock and vibration in addition to the elimination of any position sensitivity.

### CROSS-REFERENCE TO RELATED APPLICATIONS

This non-provisional application claims priority to provisional application No. 60/178,660, filed Jan. 28, 2000, which is hereby incorporated by reference in its entirety.

### TECHNICAL FIELD OF THE INVENTION

The present invention relates to optical switches, and more particularly to an optical switch which remains latched in an actuated position after actuation power is removed.

### BACKGROUND OF THE INVENTION

The development of techniques for fashioning discreet movable components in silicon and other materials on an extremely small length scale has become increasingly of interest in the past two decades. Applications for microscopic devices with moving parts, such as micromotors, pressure sensors, accelerometers, and micromirrors, often referred to generally as micro-electro-mechanical systems (MEMS) or micro-opto-electro-mechanical systems (MOEMS), have become of great interest to the automotive, biomedical, and telecommunications industries, among others.

At the same time, the advent of optical fiber technology has wrought a revolution in the telecommunications industry. Only a few decades ago, nearly all telephone calls were transmitted as information packets over a fixed physical network, usually copper telephone lines, that interconnected senders and receivers. Information packets were routed using software and/or physical switches and amplifiers in a permanent configuration. Optical fiber technology, on the other hand, has created the possibility of realizing all-optical networks in which information, including telephone calls, facsimiles, electronic mail, Internet web pages, etc. is carried as optical signals, that is light beams propagating through telecommunications optical fibers. Laser light of different wavelengths from a number of lasers may be sent through the central portion of a telecommunications optical fiber, permitting transmission of information in amounts that far exceed that possible with non-optical technologies. Optical signals in all-optical networks are typically routed using arrays of optical switches for example arrays of mirrors. Tremendous miniaturization of optical switch arrays has been made possible in large part through the advent of MEMS technology.

Microactuators form the basis of many MEMS applications. A microactuator drives the movement of mechanical components on a very small length scale. Microactuators are used in many devices, including pressure sensors, micropumps, and optical switches. For example, in an optical telecommunications network, a microactuator endowed with a reflective coating may serve as a micromirror used to direct or “switch” a laser beam from an input optical fiber to a desired destination optical fiber. The movement of the microactuator provides the micromirror with a range of motion to deflect the incident laser beam to a number of different destination fibers. Such micromirrors are typically actuated, or caused to move or change orientation from one position to another, by other microactuators which apply an actuation force to the micromirror. Typically, the micromirror remains in the actuated state only as long as the actuation force is applied to the micromirror. This has several disadvantages, among them that power must be consumed the entire time the micromirror is in an actuated state, and that active feedback is often required to align the actuated micromirror.

### SUMMARY OF THE INVENTION

This invention relates to the following methods and devices that address the disadvantages of the prior art:

A method of steering an optical beam, comprising this step:

actuating a micromirror using an actuation force to encounter a latch; mechanically latching the micromirror in an actuated position; removing the actuation force; and receiving and reflecting a free space optical beam.

This invention als relates to the foregoing method further comprising releasing the latched micromirror to an unactuated position.

This invention also relates to a method wherein the latch comprises a flexible latching post extending outwardly from an upper surface of a substrate and operably coupled to the micromirror, the latching post having a protrusion on a first face for latching the micromirror, and a first electrode on a second face.

The invention also relates to a method wherein said releasing step comprises applying a bias between the first electrode and a second electrode facing the first electrode disposed on a first face of a release post extending outwardly from the upper surface, the latching post and the release post being spaced on the upper surface.

The invention also relates to a method wherein the micromirror is an electrostatically actuated torsional micromirror.

The invention also relates to a latching mechanism for a micromirror, the latching mechanism comprising:

a flexible first latching post extending outwardly from an upper surface of a substrate and operably coupled to the micromirror, the first latching post having a first protrusion on a first face, and a first electrode on a second face; and

a first release post extending outwardly from the upper surface spaced from the first latching post on the upper surface, the first release post having a second electrode disposed on a face of the first release post facing the first electrode.

The invention also relates to a latching mechanism wherein the first protrusion provides a mechanical stop preventing passage of the edge in a second direction opposite to the first direction.

The invention also relates to a latching mechanism comprising:

a flexible second latching post operably coupled to the micromirror and extending outwardly from the upper surface, the second latching post having a second protrusion on a first face of the second latching post and a third electrode on a second face of the second latching post, the second latching post being spaced on the upper surface from the first latching post symmetrically about the micromirror; and

a second release post extending outwardly from the upper surface, the second release post having a fourth electrode disposed on a face of the second release post facing the third electrode, the second release post being spaced on the upper surface from the first release post symmetrically about the micromirror.

The invention also relates to a method of latching a micromirror comprising the steps:

actuating the micromirror in a first direction to move an edge of the micromirror past a protrusion on a first face of a flexible latching post operably coupled to the micromirror and extending outwardly from an upper surface of a substrate;

mechanically stopping passage of the edge in a second direction opposite to the first direction using the protrusion; and

bending the flexible latching post to allow passage of the edge of the micromirror past the protrusion in the second direction.

The invention also relates to a method of latching a micromirror wherein said bending step comprises applying a bias between a first electrode disposed on a second face of the flexible latching post and a second electrode facing the first electrode disposed on a face of a release post extending outwardly from the upper surface, the flexible latching post and the release post being spaced on the upper surface.

The invention also relates to a method for latching a micromirror wherein during actuation of the micromirror in the first direction, contact between the protrusion and the edge causes the latching post to flex toward the release post to allow passage of the edge past the protrusion.

The invention also relates to a mechanically latching optical switch comprising:

a micromirror actuated by a first actuation force in a first direction;

a flexible first latching post extending outwardly from an upper surface of a substrate and operably coupled to the micromirror, the first latching post having a first protrusion on a first face, and a first electrode on a second face; and

a first release post extending outwardly from the upper surface spaced from the first latching post on the upper surface, the first release post having a second electrode disposed on a face of the first release post facing the first electrode.

The invention also relates to an optical switch wherein the first protrusion provides a mechanical stop preventing passage of the edge in a second direction opposite to the first direction.

The invention also relates to an optical switch further comprising:

a flexible second latching post operably coupled to the micromirror and extending outwardly from the upper surface, the second latching post having a second protrusion on a first face of the second latching post and a third electrode on a second face of the second latching post, the second latching post being spaced on the upper surface from the first latching post symmetrically about the micromirror; and

a second release post extending outwardly from the upper surface, the second release post having a fourth electrode disposed on a face of the second release post facing the third electrode, the second release post being spaced on the upper surface from the first release post symmetrically about the micromirror.

The invention also relates to an optical switch wherein the micromirror is a torsional micromirror.

The invention also relates to an optical switch array comprising a plurality of mechanically latching optical switches as described above.

### BRIEF DESCRIPTION OF THE DRAWINGS

Embodiments of the invention will now be described by way of example with reference to the drawings in which:

FIG. 1 schematically shows a cross-sectional view of preferred embodiment of a mechanically latching optical switch.

FIG. 2a shows a top view of the electrostatically actuated torsional micromirror of the preferred embodiment of FIG. 1.

FIG. 2b shows a cross-sectional view of the electrostatically actuated torsional micromirror of the preferred embodiment of FIG. 1.

FIG. 3 shows the preferred embodiment of the mechanically latching optical switch in one of two latched states, with the actuation force removed.

FIG. 4 schematically demonstrates the release of a micromirror of the preferred embodiment of FIG. 1 from the latched state to the unactuated rest state.

FIG. 5 schematically illustrates a preferred embodiment of an optical switch array.

### DETAILED DESCRIPTION OF THE INVENTION

The invention generally relates to a method and apparatus for directing an optical beam, such as a laser beam used in an optical communications network. In optical communications networks, information-bearing optical beams carrying telephone calls, faxes, web page content, and other transmissions are guided through optical fibers from a source to a destination. It is often necessary to switch an optical beam from one fiber to another at least once in routing a transmission between the source and destination. In such cases, optical switches are used to transfer the optical beam from an input fiber to an output fiber. Micro-Electro-Mechanical (MEMS) micromirrors and microactuators are frequently used in such optical switches.

Micromirrors and microactuators, also known as MEMS mirrors and actuators, respectively, are devices whose components and operation are typically on a scale invisible or barely visible to the unaided eye usually smaller than 2 millimeters and sometimes as small as a micron. Such devices have recently become commercially available due to advances in processing technology which allow devices having intercoupled, moving components to be fabricated on a micron length scale. (A micron is a millionth of a meter, or approximately 39 millionths of an inch.) The ability to fabricate such devices on such a small scale has spawned applications in the biomedical, automotive, and telecommunications fields, among others. Applications include drug delivery systems, biosensors, pressure sensors, accelerometers, and beam steering micromirrors for optical telecommunications networks.

One form of optical switch uses micromirrors to receive an optical beam from an input fiber and reflect it toward an output fiber, in which the optical beam will continue its course toward the destination. Such micromirrors are typically actuated, or caused to move or change orientation from one position to another, by microactuators which apply an actuation force to the micromirror. For example, a micromirror might be actuated through the application of a bias or voltage (i.e. electrostatic attraction) between an electrode on the micromirror and an electrode on the microactuator, causing the micromirror to change orientation, thereby altering the path of an optical beam received and reflected by the micromirror. Typically, the micromirror remains in the actuated state only as long as the actuation force is applied to the micromirror. This has several disadvantages, among them that power must be consumed the entire time the micromirror is in an actuated state, and that active feedback is often required to align the actuated micromirror.

In the method according to the invention, a micromirror is actuated using an actuation force to encounter a latch, and the micromirror is mechanically latched in an actuated position. When the actuation force is subsequently removed, the micromirror remains in the latched position owing to the mechanical latch. While latched, the micromirror receives and reflects a free space optical beam. In the method according to the invention, the micromirror remains latched without further application of the actuation force, resulting in reduced power consumption. In a preferred embodiment, the micromirror is subsequently released to an unactuated state.

Preferred embodiments of apparatus according to the invention include a latching mechanism for a micromirror and a mechanically latching optical switch, wherein a micromirror previously actuated by an actuation force may be mechanically latched in an actuated position and remain latched when the actuation force is removed. The micromirror may subsequently be released to an unactuated state.

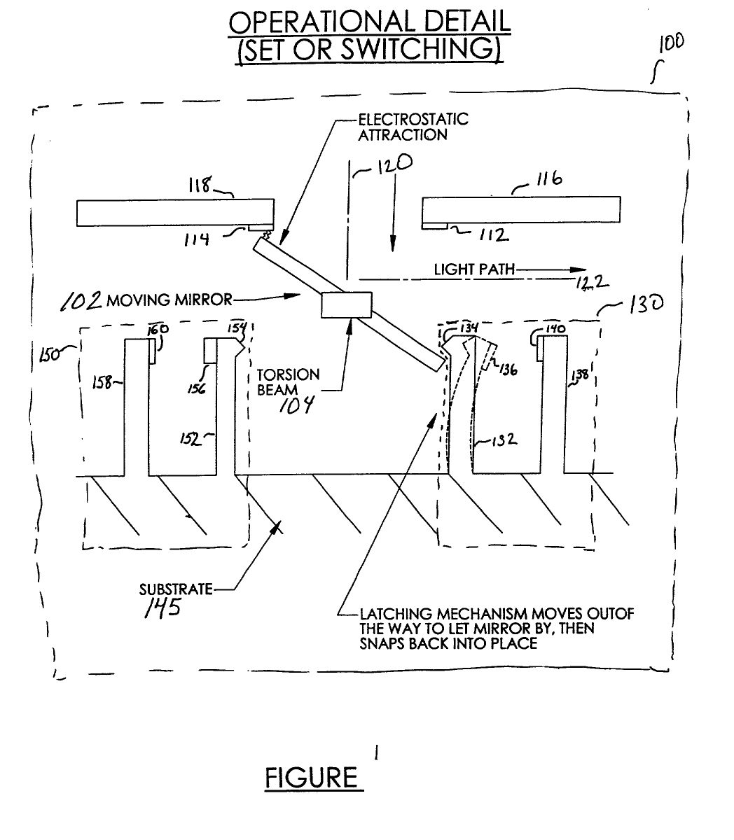

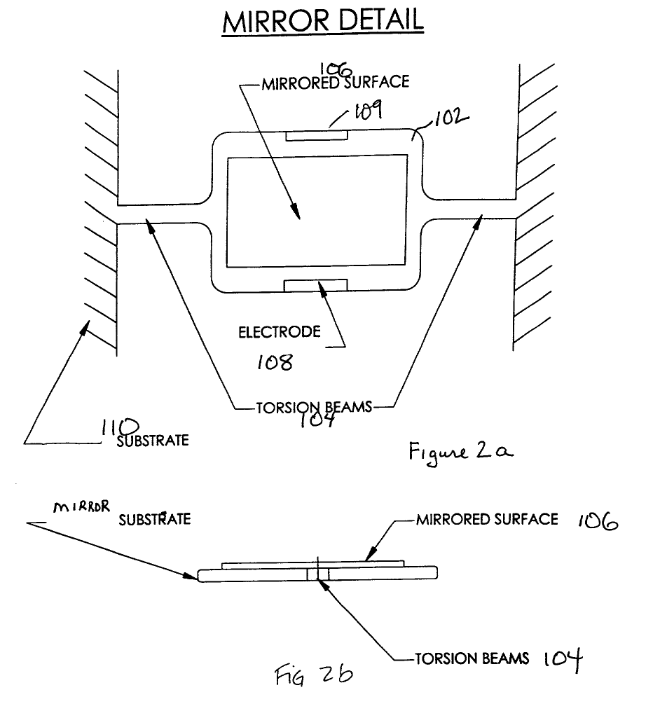

The invention will be further described with reference to the drawings. FIG. 1 schematically shows a cross-sectional view of a preferred embodiment of a mechanically latching optical switch 100 including two latching mechanisms 130 and 150. Micromirror 102 is suspended from and rotated clockwise about centered torsion beams 104 under the influence of an electrostatic actuation force arising from a bias applied between electrode 114 on electrode support 118 and electrode 108 near an edge of the micromirror (see FIG. 2). The micromirror may be rotated counterclockwise by applying a bias between electrode 112 and electrode 109 opposite electrode 108 on the micromirror. The rest or relaxed state of the switch is that in which the micromirror is not latched by one of the latching mechanisms 130, 150 and no actuation force is being applied to the micromirror. For the configuration shown in FIG. 1, a micromirror in the rest state is positioned normal to the incoming optical beam 120. When actuated by application of a bias between electrodes 114 and 118, the micromirror 102 receives and reflects the optical beam 120 as indicated by arrows in the figure. When the micromirror is actuated, the torsion beams 104 apply a torque to the micromirror in a direction opposite to the direction of actuation which tends to restore the micromirror to the rest state. This force operating in a direction opposite to an actuation force and tending to restore the micromirror to its rest state is referred to hereinafter as a “restoring force.”

The latching mechanism 130 comprises a latching post 132 and a release post 138 extending outwardly from an upper surface of a substrate 145. The latching post 132 has a protrusion 134 on a first face which makes contact with the micromirror 102 when the micromirror is actuated to encounter the latching post. As indicated by the dashed image of the latching post 132, when the micromirror 102 is actuated so as to rotate clockwise about the torsion beams 104 and encounters the protrusion 134 along an edge of the micromirror, the latching post 132 flexes toward the release post 138 into the position shown by the dashed lines, allowing the edge to move past the protrusion as the micromirror rotates further in a clockwise direction. After passage of the edge of the micromirror, the latching post 132 flexes back away from the release post 138 to its position prior to contact with the micromirror.

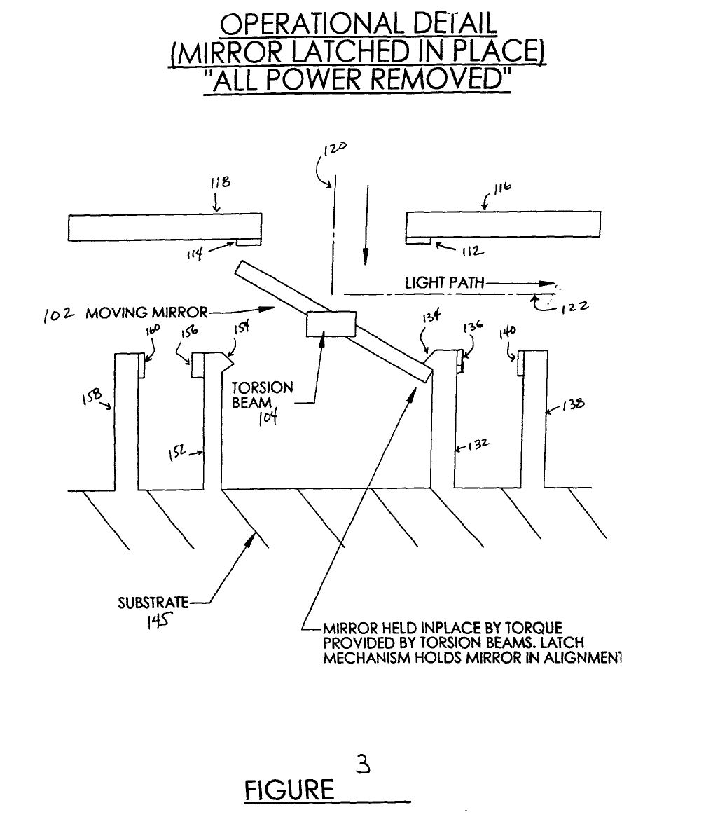

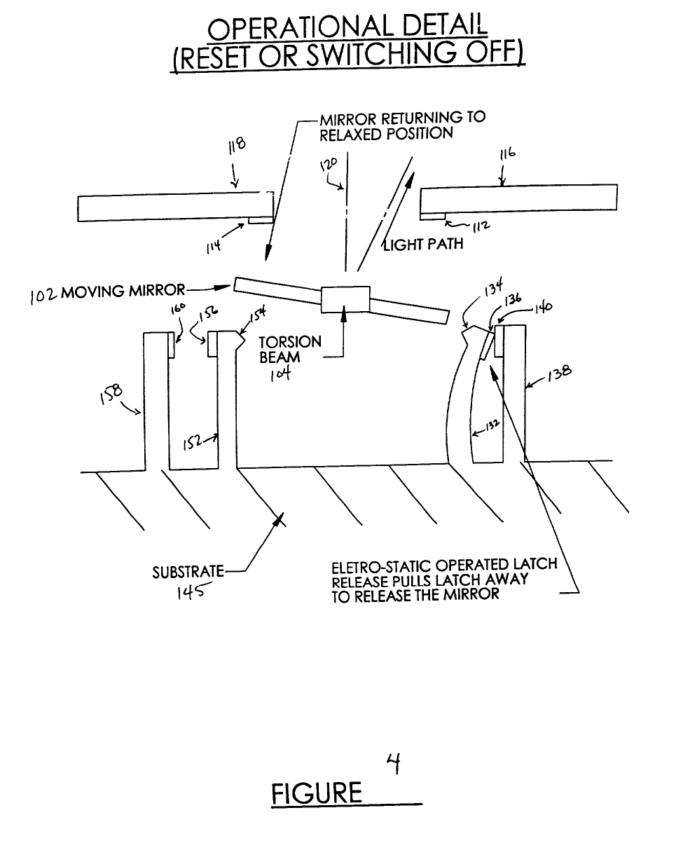

Latching post 132 has an electrode 136 on a second face and is spaced from release post 138, itself furnished with an electrode 140 disposed on a face of the release post facing electrode 136, on the upper surface of substrate 145. This arrangement allows release of the micromirror from a latched position, as will be discussed further in connection with FIGS. 3 and 4.

In the preferred embodiment shown in FIG. 1, the optical switch 100 includes latching mechanism 150, identical to latching mechanism 130 except for its orientation (being reflected about a line passing through the center of the torsion beam 104 and normal to the substrate 145), and latching mechanism 130, where the latching mechanisms 130 and 150 are spaced symmetrically about micromirror 102 on the upper surface of substrate 145. This symmetric arrangement of latching mechanisms allows the micromirror 102 to be latched in two distinct states, for example in a first state at 45° clockwise from the normal, reflecting the optical beam 90° (122), and in a second state (not shown) at 45° counterclockwise from the normal, reflecting the optical beam 90° counterclockwise. Other latching and reflection angles my be chosen as required by the particular application.

Although FIG. 1 shows a symmetric arrangement of latching mechanisms spaced about a torsional micromirror suspended from centered torsion beams, it is emphasized that this example is provided for illustrative purposed only, and the invention is not restricted to such an arrangement. In particular, a single latching mechanism, for example latching mechanism 130, may be used. In such a case, the optical switch has a rest state and a single latched state, for example 45° clockwise from the normal, reflecting the optical beam 90°. A variety of micromirror configurations also exist. For example, micromirrors suspended from non-centered torsion beams and/or micromirrors wherein the actuation and restoring forces are other than those shown in FIG. 1, for example micromirrors actuated by thermal or piezoelectric bimorphs or through magnetic forces, as is known in the art, may also be used. In addition, the tilt angle of the micromirror 102 in the latched state is not limited to the ±45° tilt angle shown in FIG. 1, but may be adjusted as required for the particular application.

FIGS. 2a and 2b show in greater detail the electrostatically actuated torsional micromirror 102 of the preferred embodiment of FIG. 1. Referring to FIG. 2a, micromirror 102 supports a mirrored surface 106 which receives and reflects optical beam 120 and has electrodes 108 and 109 on opposite edges. Micromirror 102 is suspended by torsion beams 104 from a substrate 110. FIG. 2b provides a cross-sectional view of the micromirror.

Optical switch 100 may be fabricated by techniques well known in the MEMS art, for example a combination of surface micro machining and bulk processing techniques. The preferred embodiment shown in FIGS. 1 and 2 may be fabricated, for example, using two silicon wafer substrates. The first wafer is processed to form micromirror 102 and electrode supports 116 and 118, while the second is processed to form latching mechanisms 130 and 150. The two wafers are then bonded together to form the finished optical switch 100.

Reference is now made to FIG. 3, in which reference numbers identical to FIG. 1 are used. FIG. 3 shows the optical switch 100 in one of two latched states, with the actuation force (supplied by the bias previously applied between electrodes 114 and 108) removed. With the actuation force removed from the micromirror 102, previously actuated in a clockwise direction, the torsional restoring force applied by the torsion beams 104 causes the micromirror to rotate counterclockwise until the edge of the micromirror makes contact with the protrusion 134, which prevents the micromirror from rotating further. As shown in FIG. 3, the micromirror is latched, held securely in place by the opposing torsional and normal forces supplied by the torsion beams and protrusion, respectively. The protrusion 134 provides a mechanical hard stop, which provides repeatable alignment for the micromirror, and hence the optical beam 120. In this way, the latching mechanism 130 eliminates position sensitivity problems arising in non-latching prior art systems and also provides vibration tolerance.

FIG. 4 schematically demonstrates the release of the micromirror from the latched state to the unactuated rest state. A bias, for example a voltage pulse, is applied between electrodes 136 and 140, causing the latching post 132 to bend toward the release post 138, as shown in FIG. 4, thereby allowing the edge of the micromirror to pass the protrusion 134. The micromirror is thereby allowed to return to the unactuated rest state under the influence of the restoring force, which is supplied in the preferred embodiment shown by the torsion beams 104. The bias between electrodes 136 and 140 must be applied for a time interval sufficient to allow the edge of the micromirror to pass the protrusion 134, an interval which may be calculated and/or determined empirically. If a voltage pulse is used, the pulse width of the release cycle is such that the latching post remains bent toward the release post long enough for the edge of the micromirror to pass the protrusion.

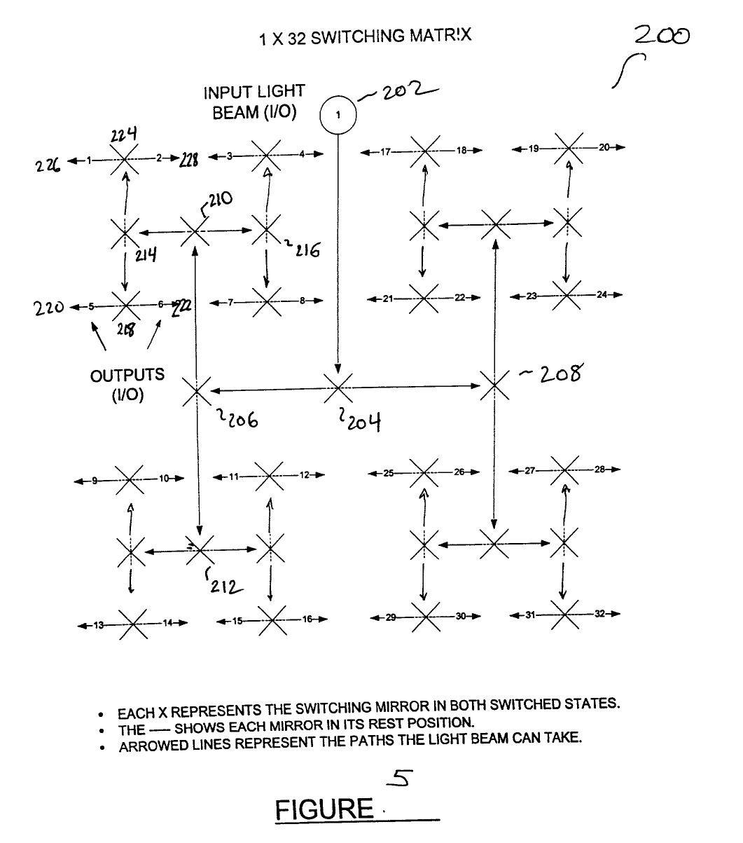

An optical switch array can be constructed using the principles of the invention which enables matrix switching of any number of input/output configurations. A preferred embodiment of such an optical switch array is the 1×32 optical switch array 200 shown in FIG. 5. The array 200 comprises 31 micromirrors 204, 206, 208, 210, 212, 214, 216, 218, 224, etc., which may be in an unactuated rest state or switched into either of two latched states. Each “X” represents the two possible switched states of each micromirror, while the dashed lines represent each micromirror in the rest state. Arrows represent allowed light beam paths. Numbered arrows 1 to 32 represent the 32 possible optical beam outputs for this array. Operation of the array is straightforward and may be understood with reference to the drawing: An optical beam from an input fiber 202 may be received and reflected by micromirror 204 toward either micromirror 206 or micromirror 208. If the beam is then received by micromirror 206, it may be reflected toward micromirror 210 or 212. In like manner the latched state of a micromirror receiving the optical beam determines to which one of two micromirrors the beam will subsequently be reflected. In one example, the optical beam is received in sequence by micromirrors 204, 206, 210, 214, and 218 and subsequently exits the array as the output 220. In the preferred embodiment shown in FIG. 5, the micromirrors are selectively tilted at ±45° to direct the optical beam ±90° from the angle of incidence. An integrated electronics decoder may be used to select which micromirrors are to be switched and which direction they are to face, i.e. to which of the two possible latched states the micromirror will be switched. Similarly, an integrated electronics decoder may be used to release selected micromirrors from the latched state to the unactuated rest state. In a preferred embodiment, the entire optical switch array is fabricated on a single silicon wafer; however, arrays having both larger and smaller surface areas are also contemplated.

Variations of the configuration shown in FIG. 5 will be apparent to those skilled in the art. For example, the number of micromirrors in the array may easily be increased or decreased, thereby increasing or decreasing the number of outputs. The tilt angle of the micromirrors in the latched state (±45° in FIG. 5) may also be varied. Micromirrors having only one latched state, as opposed to the two latched states shown in FIG. 5, may also be used. In addition, any suitable method of actuation of the micromirrors may be used.

The method and apparatus of the invention overcome the inadequacies of the prior art by providing a MEMS solution for optical beam steering which allows low power actuation and fixed latching without the need for additional power after switching has occurred. The latching mechanism provides a fixed stop which eliminates the need for active feedback to align the switching micromirror and provides tolerance to shock and vibration in addition to the elimination of any position sensitivity.

Various embodiments of the present invention have now been described. While these embodiments have been set forth by way of example, various other embodiments and modifications will be apparent to those skilled in the art. Accordingly, it should be understood that the invention is not limited to such embodiments, but encompasses all that which is described in the following claims.

What is claimed is:

1. A method of steering an optical beam, the method comprising:
actuating a micromirror using an actuation force to encounter a latch;
mechanically latching the micromirror in an actuated position;
removing the actuation force; and
receiving and reflecting a free space optical beam.

2. The method according to claim 1, further comprising releasing the latched micromirror to an unactuated position.

3. The method according to claim 2, wherein the latch comprises a flexible latching post extending outwardly from an upper surface of a substrate and operably coupled to the micromirror, the latching post having a protrusion on a first face for latching the micromirror, and a first electrode on a second face.

4. The method according to claim 3, wherein said releasing step comprises applying a bias between the first electrode and a second electrode facing the first electrode disposed on a first face of a release post extending outwardly from the upper surface, the latching post and the release post being spaced on the upper surface.

5. The method according to claim 1, wherein the micromirror is an electrostatically actuated torsional micromirror.

6. A latching mechanism for a micromirror, the latching mechanism comprising:
a flexible first latching post extending outwardly from an upper surface of a substrate and operably coupled to the micromirror, the first latching post having a first protrusion on a first face, and a first electrode on a second face; and
a first release post extending outwardly from the upper surface spaced from the first latching post on the upper surface, the first release post having a second electrode disposed on a face of the first release post facing the first electrode.

7. The latching mechanism according to claim 6, wherein the first protrusion provides a mechanical stop preventing passage of the edge in a second direction opposite to the first direction.

8. The latching mechanism according to claim 6, further comprising:
a flexible second latching post operably coupled to the micromirror and extending outwardly from the upper surface, the second latching post having a second protrusion on a first face of the second latching post and a third electrode on a second face of the second latching post, the second latching post being spaced on the upper surface from the first latching post symmetrically about the micromirror; and
a second release post extending outwardly from the upper surface, the second release post having a fourth electrode disposed on a face of the second release post facing the third electrode, the second release post being spaced on the upper surface from the first release post symmetrically about the micromirror.

9. A method of latching a micromirror, the method comprising:
actuating the micromirror in a first direction to move an edge of the micromirror past a protrusion on a first face of a flexible latching post operably coupled to the micromirror and extending outwardly from an upper surface of a substrate;
mechanically stopping passage of the edge in a second direction opposite to the first direction using the protrusion; and
bending the flexible latching post to allow passage of the edge of the micromirror past the protrusion in the second direction.

10. The method according to claim 9, wherein said bending step comprises applying a bias between a first electrode disposed on a second face of the flexible latching post and a second electrode facing the first electrode disposed on a face of a release post extending outwardly from the upper surface, the flexible latching post and the release post being spaced on the upper surface.

11. The method according to claim 9, wherein during actuation of the micromirror in the first direction, contact between the protrusion and the edge causes the latching post to flex toward the release post to allow passage of the edge past the protrusion.

12. A mechanically latching optical switch comprising:
a micromirror actuated by a first actuation force in a first direction;
a flexible first latching post extending outwardly from an upper surface of a substrate and operably coupled to the micromirror, the first latching post having a first protrusion on a first face, and a first electrode on a second face; and
a first release post extending outwardly from the upper surface spaced from the first latching post on the upper surface, the first release post having a second electrode disposed on a face of the first release post facing the first electrode.

13. The optical switch according to claim 12, wherein the first protrusion provides a mechanical stop preventing passage of the edge in a second direction opposite to the first direction.

14. The optical switch according to claim 12, further comprising:
a flexible second latching post operably coupled to the micromirror and extending outwardly from the upper surface, the second latching post having a second protrusion on a first face of the second latching post and a third electrode on a second face of the second latching post, the second latching post being spaced on the upper surface from the first latching post symmetrically about the micromirror; and
a second release post extending outwardly from the upper surface, the second release post having a fourth electrode disposed on a face of the second release post facing the third electrode, the second release post being spaced on the upper surface from the first release post symmetrically about the micromirror.

15. The optical switch according to claim 12, wherein the micromirror is a torsional micromirror.

16. An optical switch array comprising a plurality of mechanically latching optical switches according to claim 12.

17. An optical switch array comprising a plurality of mechanically latching optical switches according to claim 14.
